(19) United States
(12) Patent Application Publication
(10) Pub. No.: US 2011/0116604 A1
(43) Pub. Date: May 19, 2011

(54) Plasma-based generation of X-radiation with a sheet-shaped target material

(76) Inventors: Manfred FAUBEL, Rosdorf (DE); Ales CHARVAT, Gottingen (DE); Jurgen TROE, Gottingen (DE); Bernd ABEL, Dransfeld (DE); Jens ASSMAN, Mannheim (DE); Eugene LUGOVOI, Gottingen (DE)

(21) Appl. No.: 10/560,122

(22) PCT Filed: Jun. 9, 2004
(86) PCT No.: PCT/EP2004/006263

§ 371 Date: Apr. 28, 2006

(30) Foreign Application Priority Data
Jun. 11, 2003 (DE) 103 26 279.2

(51) Int. Cl. H05G 2/00; H01J 35/08

(52) U.S. Cl. 378/143; 378/119

(57) ABSTRACT

Methods for the plasma-based generation of X-radiation are described with the steps: provision of a target material (50) in the form of a free flow structural formation (51) in a vacuum chamber (20), and irradiation of the target material (50) in order to produce a plasma condition in which the X-radiation is radiated therefrom, the flow structural formation (51) being formed in such a way that the target material has, at least at the location of the irradiation, a surface (52) with a local curvature minimum. Devices for the imple mentation of the methods and, in particular, X-ray sources for the plasma-based generation of X-radiation are also described.

The invention refers to methods for plasma-based generation of X-radiation with the features of the preamble of Claim 1, X-ray sources for plasma-based generation of X-radiation with the features of the preamble of Claim 22 and methods for the injection of a liquid target material into a vacuum chamber.

The generation of X-radiation with X-ray sources is known, where a target material is transposed into a plasma condition by means of high-energetic irradiation (e.g., laser irradiation) and where, material-specifically, an X-ray fluorescence radiation is radiated. Initial developments took place with solid sheet-shaped target materials. However, solid target materials have a relatively high mass density, so that a relatively large amount of material is also released during the plasma excitation, which is disadvantageous for practical applications. An improvement is achieved with the use of liquid, drop-shaped target materials. For example, according to EP 186 491, in an evacuated chamber with a piezoelectric drop dispenser a sequence of liquid drops is produced where each of which is transposed into a plasma condition by means of laser irradiation. From the plasma condition, the emission of soft X-radiation is effected which exits through a window in the chamber or is collected with an optical system. Progress was achieved with the use of liquid target materials. Up to the present, however, these X-ray sources have had a series of disadvantages that are tolerated depending on the individual application or are compensated by means of special pre-cautionary measures.

The X-ray source according to EP 186 401 is limited to the use of mercury as a liquid target material. Accordingly, the X-radiation that can be generated is restricted to certain spectral lines. A further disadvantage of mercury is its relatively high vapor pressure, which causes problems when collecting the mercury and also causes impurities in the chamber. Liquid metals are generally incompatible with the sensitive and extremely cost-intensive X-ray optical systems. In this way, damage can occur on gold optical systems, which are standard for example in Fresnel zone X-ray microscopy, as a result of mercury-amalgam compounds. In order to avoid impurities, the use of frozen water crystals as a target material is proposed in U.S. Pat. No. 5,459,771. However, this technique has the disadvantage of a large device-technical expenditure for the generation of crystals and for the collection of the target material.

Further liquid target materials have been proposed particularly for applications in the X-ray lithography. The use of ethanol as a liquid material is described by L. Rymell et al. in “Rev. Sci. Instrum” Volume 66, 1995, pages 4916-4920. However, ethanol or other monomeric liquids have the disadvantage that target molecules gain access to the gas phase as a result of the plasma excitation and deposit themselves on the surfaces of sensitive components. The deposited molecules are decomposed by the generated X-radiation wherein, in the case of alcohols, tar-type decomposition products occur which precipitate as undesirable impurities in the X-ray source and on optical structural components in particular. In order to reduce these radiation-induced decompositions, a shielding with a gas spray is provided. By means of this, however, the structural configuration is made complicated in a disadvantageous manner. According to WO 97/40650, ammonia, water or fluorine-containing liquids are used as target material in addition to ethanol. In order to counteract a further general disadvantage of conventional liquid target materials, namely the difficult drop formation as a result of low viscosity, WO 97/40650 proposes the introduction of the target material in the form of a thin jet into the chamber of the X-ray source. However, monomeric target material is also used with this technique so that the problems as described above occur from radiation-induced decompositions of precipitations. The use of water as a target material is also known from U.S. Pat. No. 6,377,651. The use of nitrogen, carbon dioxide, krypton or xenon is proposed in U.S. Pat. No. 6,324,255.

The use of fluorinated hydrocarbon compounds (CₙFₘ) is proposed by L. Malmqvist et al. in “Appl. Phys. Lett.”, Volume 68, 1996, pages 2627-2629. These are well adapted to the generation of fluorine lines (λ≈1 to 2 nm) but have also, however, several disadvantages. First of all, the so-called perfluoro hydrocarbons have a high vapor pressure, which makes difficult the formation of a liquid jet and the collection of the target material following the plasma excitation. For example, the vapor pressure of perfluoropentane at 0° C. already amounts to 0.3 bar. Furthermore, particularly with applications in the sphere of X-ray spectroscopy, the generation of further longer-wave lines such as, for example, the generation of carbon emissions is of interest. However, alcohols have been used as target material for this purpose up to now (Rymell et al., see above).

A general disadvantage of the conventional plasma-based generation of X-radiation lies in the low level transformation effectiveness during the irradiation of the target material for the generation of the plasma condition. With an increasing atom mass of the target material, the transformation effectiveness can be increased, but at the same time and with increasing atom mass, it becomes more difficult to establish the target material in liquid condition. The efficiency of the transposition of particularly liquid target material into the plasma condition, meaning the ratio of the atoms or molecules of the target material excitated in the plasma condition to the in-beamed energy of the laser light is relatively small as a result. For example, an efficiency of only 0.75% for the generation of EUV-light is stated by B. A. M. Hansson et al. (“Proceedings of SPIE”, Volume 4688, 2002, pages 102 to 109).

Up to the present, efforts were made to improve the focusing of the in-beamed laser light for the purpose of increasing the efficiency. However, under practical conditions the focusing was a considerable problem as the target material up to now is established in the form of a jet or in form of drops with typical diameters in the range of, for example, 10 μm to 40 μm. An enlargement of the jet diameter, which would facilitate the focusing, would involve a greater strain on the vacuum in the vacuum chamber. The efforts for achieving the smallest possible material input into the vacuum chamber, therefore the smallest possible diameter of the jet or drops, practiced so far makes additionally difficult the focusing of the laser light for plasma generation.

The object of the invention is to provide improved methods particularly for plasma-based generation of X-radiation with which the disadvantages of the conventional techniques are overcome and which are characterized in particular by an increased efficiency during plasma generation and, thus, during the generation of X-radiation and a simplified focusing capability of the external irradiation for the generation of the plasma condition at constant or reduced material input into the vacuum chamber. It is also the object of the invention to provide improved target materials for the plasma-based generation of X-radiation (especially soft X-radiation or extreme UV-radiation) with which the disadvantages of conventional target materials are overcome and that are suitable for the implementation of the methods according to the invention. The target materials should solve in particular the conventional problems with the collection of the target material and prevent the generation of impurities. Finally, it is also the object of the invention to provide an improved X-ray source that is suitable for the improved methods for plasma-based generation of X-radiation.

These objects are solved by methods and X-ray sources with the features according to Patent Claims 1 and 22. Advantageous embodiments and applications of the invention result from the dependent Claims.

With reference to methods, the invention is based on the general technical teaching of further developing a method for the plasma-based generation of X-radiation where target material is high-energetically irradiated in form of a free flow structural formation in a vacuum chamber for the generation of a plasma condition, in which the X-radiation is radiated, such that the flow structural formation is formed with a surface which has various curvature radii, the target material having at least at the location of the irradiation one surface with a local curvature minimum (local maximum of the curvature radius). The target material is thus irradiated at a location, at which the flow structural formation has a less stronger curvature than along the surrounding surface or is oppositely (negative) curved even relative to other parts of the surface. This means that the cross-sectional surface of the flow structural formation is deformed deviating from the conventionally realized circular form into a long-stretched form or, as required, into a concave form on at least one side.

A free flow structural formation is generally understood to be an expanding liquid flowing with a defined surface, for example, in the form of a jet or a liquid sheet flowing apart. The liquid flows freely, therefore with a free surface on all sides and without binding to a carrier through the vacuum chamber. The flow structural formation has a fixed space-form which thus is essentially unchanged in the time sequence.

The advantages of the flow structural formation formed according to the invention result from the following findings of the inventors. The inventors have ascertained that, with the enlargement of the diameter of a conventionally formed jet of the target material, a considerable improvement of the efficiency during plasma generation is obtained as a result. It was determined that the improvement is not solely attributable to a larger substance volume in the focus of the external irradiation but rather on the following effect. A jet of the target material with an enlarged diameter has a less curved surface, and this is more favorable for the input of the external radiation energy. At a less curved surface, a larger portion of the focused irradiation with a steeper angle of incidence can hit the target material, so that the reflection losses are reduced.

An enlargement of the jet diameter of the target material is undesirable, however, because of the increased material input into the vacuum chamber involved with this. The invention solves this contradiction where the flow structural formation has, completely or at least at the location of the irradiation, a non-circularcylindrical form. In this way and with a constant material input, the curvature radius of the target surface can be at least locally maximized. The inventors have ascertained that surprisingly free liquid formations can be created in the vacuum which, contrary to the endeavors with reference to the surface tension for forming a cylindrical or spherical form for surface minimization, are sufficiently stable in order to form the desired flow structural formation or pattern.

The irradiation of the flow structural formation at a local curvature minimum of the surface has a series of advantages. First of all, the angle of incidence of the irradiation can be optimized. Reflection losses are reduced. The efficiency of the plasma generation can be significantly increased. Furthermore, the target material can offer a larger, free surface for irradiation at constant material input. This simplifies the focusing of laser light onto the target material and makes possible a simplification of the structural configuration of the X-ray source. On the other hand and by means of the increased efficiency of the plasma generation, a target material with relatively high vapor pressure with smaller jet dimensions can be introduced without causing a major reduction of the X-ray intensity.

A further particular advantage lies in the fact that, by contrast with the conventional cylindrically or spherically shaped target material from which the X-radiation emanated with an isotropic distribution, an anisotropic X-ray emission takes place with the method according to the invention. This can be utilized for a further efficiency increase with the generation of X-radiation. Furthermore, the anisotropy of the emitted X-radiation is measurable with reference to the target surface and is also adjustable by means of a predetermined turning of the target surface.

According to a preferred embodiment of the invention, the flow structural formation self-supportingly formed in the vacuum chamber is provided with a long-stretched cross-sectional surface. The given cross-sectional surface perpendicular to the main flow direction of the flow structural formation has in a main axis direction a larger expansion than in a deviating secondary axis direction, for example standing 90° on the main axis direction. With this, the local curvature minimum on the at least one side of the flow structural formation is established which corresponds to the minimum transverse expansion of the cross-sectional surface. This embodiment of the invention has the particular advantage that the target material, corresponding to the secondary axis direction, provides a particularly large surface for the external irradiation. The cross-sectional surface has preferably an oval, e.g., elliptical or a rounded-off rectangular form. These variants can have advantages with reference to the provision of the flow structural formation with one or several nozzles and the handling of the target material in the vacuum chamber.

It is particularly advantageous if the flow structural formation forms at least at the location of the external irradiation a self-supporting liquid sheet or liquid lamella. The surface of the liquid sheet can form a plane or infinitesimally curved surface into which externally in-beamed laser light is particularly effectively injectable.

If the external irradiation, particularly with laser light, on the target material takes place substantially vertical on the surface with the local curvature minimum, e.g., on the surface of the free liquid sheet, reflection losses during the irradiation can be best reduced advantageously and, accordingly, the efficiency of the plasma generation can be increased.

The inventors have developed various methods with which the flow structural formation can be formed with the desired flattened-off surface. According to a first variant, the flow structural formation is produced with a target source that has a nozzle with a non-circular cross-section. Surprisingly, it turned out that the flow form which is characteristically applied to the flow structural formation with, for example, a flattened-off nozzle, remains upheld in the vacuum chamber over sufficiently large flow lengths. Particular advantages can result for the generation of a liquid sheet if a nozzle with a slot-formed cross-section is used.

If the flow structural formation according to a variant of the invention has a concave surface at least on the one side or preferably on both sides, meaning a surface with a negative curvature radius, the thickness of the flow structural formation can be advantageously reduced particularly at the location of the irradiation. In this way, the material released during the irradiation in the vacuum chamber can be diminished.

According to a further embodiment of the invention, the use of a rotatable nozzle with a non-circular cross-section makes possible the adjustable setting of a predetermined alignment of the nozzle and, subsequently, the target material relative to the direction of the irradiation of the target material. The nozzle can be adjusted around an axis corresponding to the main flow direction of the flow structural formation in such a way that the irradiation of the target material takes place essentially perpendicular on the surface of the flow structural formation.

According to a second variant it is provided that the flow structural formation is produced with two primary jets of the target material led together at an angle. At the location of meeting of the primary jets a divergent flow occurs on all sides during the impact on one another, where a flow formation that is essentially sheet-shaped is generated. This variant can have advantages with reference to the flexibility during the setting of the flow structural formation by means of variation of the flow properties of the participating primary jets.

The generation of impact surfaces between liquids flowing together is described by G. Taylor in “Proceedings of the Royal Society A”, Volume 259, 1960, pages 1 to 17. However, the former findings of G. Taylor were collected on macroscopic systems (nozzle diameter: some centimeters) at normal pressure. The inventors have found that the desired flow structural formations can surprisingly also be realized at sub-atmospheric pressure and with microscopically small liquid jets (microjets).

If the primary jets are led together in a countercurrent fashion at an angle of 180°, an axial-symmetrical flow structural formation can be advantageously produced. If the primary jets are led together at a smaller angle, advantages can result for the structural configuration of the X-ray source. The angles of intersection of the primary jets are preferably smaller than or equal to 180° (as for example)120°, particularly smaller than or equal to 90°.

A further particular advantage of the invention is that the generation of the flattened-off flow structural formation is realizable with the target materials known as such for the generation of X-radiation, such as for example water, glycerine, alcohol, liquefied gas, particularly liquefied inert gas, such as for example xenon or liquid metal. However, a target material is preferred that consists of at least one hydrocarbon compound that comprises at least one polymer, which is liquid at ambient temperature. The use of liquid polymer hydrocarbon compounds has a series of advantages with reference to the provision of the target material in an X-ray source, the avoidance of impurities and the structural configuration of the X-ray source as presented as follows.

Firstly, the liquid polymer target material is not-easily volatile. Not-easily volatile substances are particularly easy to remove from a vacuum chamber in which the plasma is excitated for radiation. generation. The substances can be collected directly as liquid in a trap and, at that location, can be separated under their own vapor pressure. A further vacuum system for evacuating the trap is not compellingly required so that the structural configuration of the X-ray source is considerably simplified.

Secondly, the desired area form of the flow structural formation can be produced with liquid polymers with a particularly high spatial stability. This means that the flattened-off surface of every flow structural formation can be provided with a comparably large distance from the nozzle of the target source, for example up to 100 mm, and this fact considerably facilitates the focusing of the external irradiation.

Thirdly, erosion damage in the vacuum chamber is diminished by the applied polymers according to the invention. The inventors have discovered that erosion damage can occur as a result of the interaction of the gas atmosphere, which always forms based on the vapor pressure of a liquid target, and the generated X-radiation. Target molecules existing in the gas atmosphere are ionized as a result of the radiation. The depositing of the ions on surfaces in the vacuum chamber, for example on nozzles for introducing the target material, cause a plasma etching through which the individual material is eroded. The polymer target material according to the invention is not-easily volatile so that the particle concentration in the gas atmosphere and possible erosion damage are minimized.

Fourthly, the precipitation of polymer target material in the vacuum chamber is non-critical. From the polymers, easily volatile products originate during radiation-induced decomposition and these can be pumped out of the vacuum chamber without any complications. A target material precipitation can, according to the invention, act as a protective film on components of the vacuum chamber and this can prevent high-energetic polymer fragments from gaining direct access onto the components and, as necessary, can be easily removed during a cleaning process.

According to a preferred embodiment of the invention, the liquid polymer has at least one ether binding between carbon atoms. With the use of a hydrocarbon with at least one ether binding (or oxygen bridge), advantages are obtained that also have a positive effect on all phases of the plasma-based generation of X-radiation. The oxygen bridge compounds between carbon atoms cause a high molecular flexibility. This causes a high molecular flexibility (or: low viscosity) of the polymer target material. The low viscosity advantageously effects the generation of the flattened-off flow structural formation as well as the decomposition into low molecular constituents following the plasma excitation. Furthermore, the composition of the target material particularly from fluorine, carbon and oxygen, establishes an expanded application range of the target material. A universal target is provided for various applications.

It is particularly advantageous if a polymer, which is liquid at ambient temperature (about 20° C.) is used as a target material, which comprises at least one partially fluorinated or perfluorinated polymer hydrocarbon ether. The partial or complete fluorination of the polymer supports the formation of easily volatile decomposition products during X-ray irradiation.

As a target material, a perfluoropolyether (PFPE) or a mixture from several perfluoropolyethers is preferably used. PFPE-compounds are high-molecular, through which the flow structural formation is furthermore supported. In addition, and by means of a break-up of oxygen bridges during energy input, they can decompose into easily volatile compounds, which can be easily pumped off. In this way deposits and impurities can be avoided, particularly on optical components in the X-ray source. With the invention, the expensive and sensitive X-ray optics are advantageously protected. Non-decomposed residuals of the target material can be particularly easily collected in the vacuum chamber also without any special precautionary measures for condensation.

According to preferred embodiments of the invention the polymer target material has a vapor pressure which, at ambient temperature, is lower than 10 mbar, preferably lower than 1 mbar, e.g., 10⁻⁶ mbar, and has a molecular weight larger than 100 g/mol, preferably larger than 300 g/mol, e.g. in the range 400 to 8000 g/mol, and/or at ambient temperature a viscosity that is selected in the range of 1 to 1800 cS. The mass density of the target material preferably lies in the range of 1.5 to 2.5 g/mol, e.g., 1.8 to 1.9 g/mol. With these parameters, provided if necessary in combination, the forming of the target material and the collecting of material residuals following plasma excitation is improved.

The irradiation of the target material, particularly of the liquid polymer target material is effected according to a preferred embodiment of the invention in a surrounding under a pressure that is higher than the gas pressure of the released material during irradiation. By means of the increase of the vapor pressure of the target material in the vacuum chamber, a local oversaturation during plasma generation is avoided and, subsequently, a droplet formation in the vacuum chamber. In this case, the released gas remains for the greater part in the gas phase. The discharge from the vacuum chamber is carried out by pumping. Advantageously in this case, diminished requirements are established for the vacuum conditions in the chamber of an X-ray source, so that the method can be carried out with less device-technical expenditure.

With reference to devices, the above-mentioned object is solved by the provision of an X-ray source for plasma-based generation of X-radiation, which has a target source for providing the target material in form of a free flow structural formation in a vacuum chamber and an irradiation device for high-energetic irradiation of the target material and, according to the invention, is developed such that the target source is adapted for the purpose of characteristically applying a flow form to the target material so that a flow structural formation is formed having in at least one surface area a local curvature minimum.

According to a preferred embodiment of the invention, the target source has a nozzle with a non-circular cross-section with which the desired flow pattern is characteristically applied to the target material. A nozzle with a slot-shaped port is particularly preferred because, with this, an essentially sheet-shaped flow structural formation can be formed.

According to a particularly preferred embodiment of the invention, the nozzle has in particular at its outlet opening a cross-sectional surface that is tapered to the inside at least on one side. The concave flow structural formation as described above is advantageously formed with this configuration. If the nozzle is arranged in the vacuum chamber in a rotatable manner, advantages can result for the alignment of the flow structural formation for an optimum external irradiation.

According to an alternative embodiment of the invention, the target source is equipped with two nozzles, which are set up for the generation of primary jets that hit on each other in the vacuum chamber at a predetermined angle. If the nozzles are aligned to each other at an angle of 180°, advantages can result for an even forming of the flow structural formation. If the nozzles are aligned to each other at an angle smaller than or equal to 90°, advantages can result for the configuration of the X-ray source and the flexibility during the forming of the flow structural formation.

According to a further embodiment of the invention, the X-ray source has at least one heating device with which at least parts of the vacuum chamber can be tempered. The provision of the at least one heating device results particularly in advantages during the use of the above-mentioned polymer target material because, with the heating device, the vapor pressure of the target material can be set higher than the pressure of the gas that is released during the irradiation of the target material. With a temperature increase, the vapor pressure can be increased and this provides advantages for the configuration of the vacuum device and the diminishing of precipitations.

If the X-ray source is provided with an irradiation optical system arranged in the vacuum chamber for irradiation the target material, it can be advantageous to connect a heating device with the irradiation optical system, so that precipitations of the target material onto this can be avoided.

With the increase of the effectiveness of the irradiation and the plasma generation, the efficiency of the X-ray source increases. If the irradiation optical system is arranged outside of the vacuum chamber, a separate heating device at the irradiation optical system can be advantageously dispensed with. The result is a simplified structural configuration of the X-ray source.

According to a further preferred embodiment of the invention, the X-ray source is equipped with a collection device for coolant-free collecting of target material residuals. The X-ray source according to the invention has the advantage of having a simplified structural configuration. As a result of the stability of the flow structural formation of the target material, the adjustment of an irradiation device for the excitation of the plasma condition is simplified. With the deployment of an uncomplicated vacuum system and the avoidance of a sophisticated cooling device, the X-ray source is suitable for use as a mobile device unit for an extended application field in laboratories and in industry.

According to a preferred embodiment of the invention, the X-ray source is combined with an X-ray lithography device, e.g., for structuring the semiconductor surfaces. In this case, the X-ray lithography device can be arranged in the vacuum chamber in the immediate vicinity of the location of the X-radiation generation. By contrast with the conventional systems, this is possible for the first time due to the small droplet formation and diminished precipitations of the target material used according to the invention. In reverse, the X-ray source can be directly integrated into an X-ray lithography device. Preferably, the X-ray lithography device is provided with its own heating device so that, as necessary, occurring residual precipitations can be easily transferred into the gas phase and pumped off.

According to a modified embodiment of the invention, the vacuum chamber of the X-ray source can be combined with an additional vacuum chamber, which contains the X-ray lithography device. With the simplified structural configuration of the X-ray source according to the invention, both vacuum chambers can be arranged in a narrow space.

The X-ray source according to the invention has the particular advantage that the X-radiation (or corresponding radiation in the distant UV-range) can be generated during continuous operation. The plant can work practically without interruption (e.g., over days), which is particularly important for industrial applications of the X-ray source.

Further subjects of the invention, which can be realized analogously to the embodiments described below, however independent of the generation of X-radiation, are a vacuum chamber with a nozzle having a slot-shaped outlet opening for the injection of liquid target material into the vacuum chamber and methods for the injection of a liquid target material in form of a free flow structural formation into a vacuum chamber, the flow structural formation being formed in such a way that the target material has a surface with a local curvature minimum and, preferably, forms a free lamella-formed sheet.

Further details and advantages of the invention are described as follows with reference to the attached drawings. These drawings show the following:

FIG. 1: a schematic illustration of the irradiation of a non-cylindrical flow structural formation,

FIGS. 2 and 3 illustrations of the jet formation with a slot-shaped nozzle,

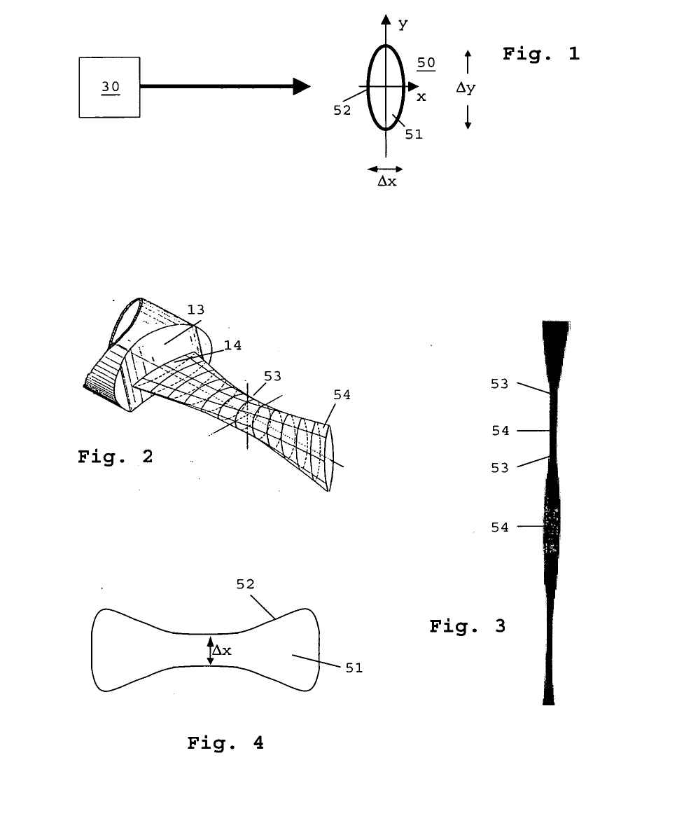

FIG. 4: a schematic illustration of the cross-sectional surface of a concave flow structural formation,

FIGS. 5 and 6: illustrations of a slot-shaped nozzle,

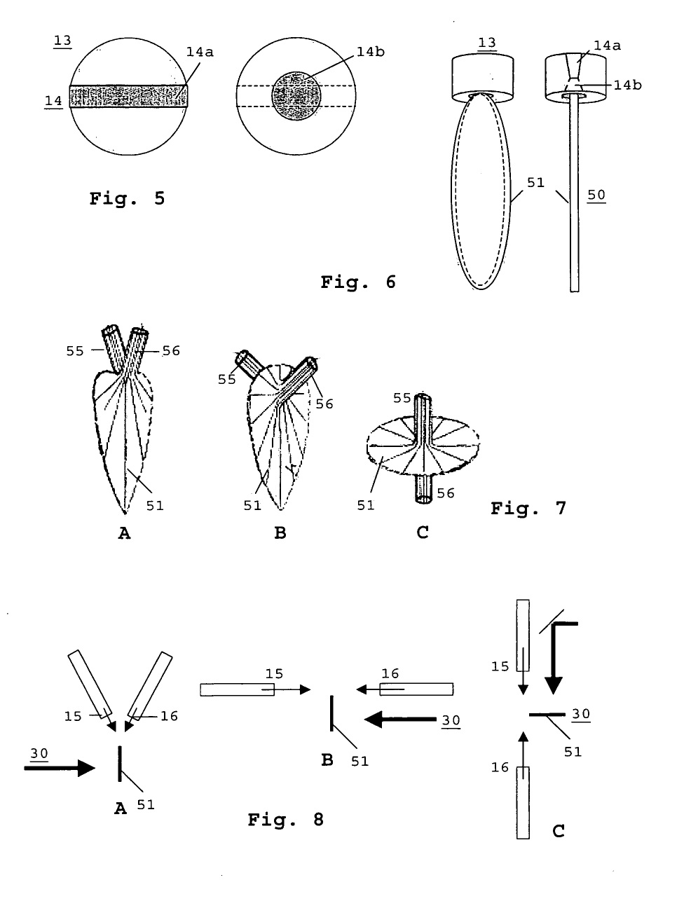

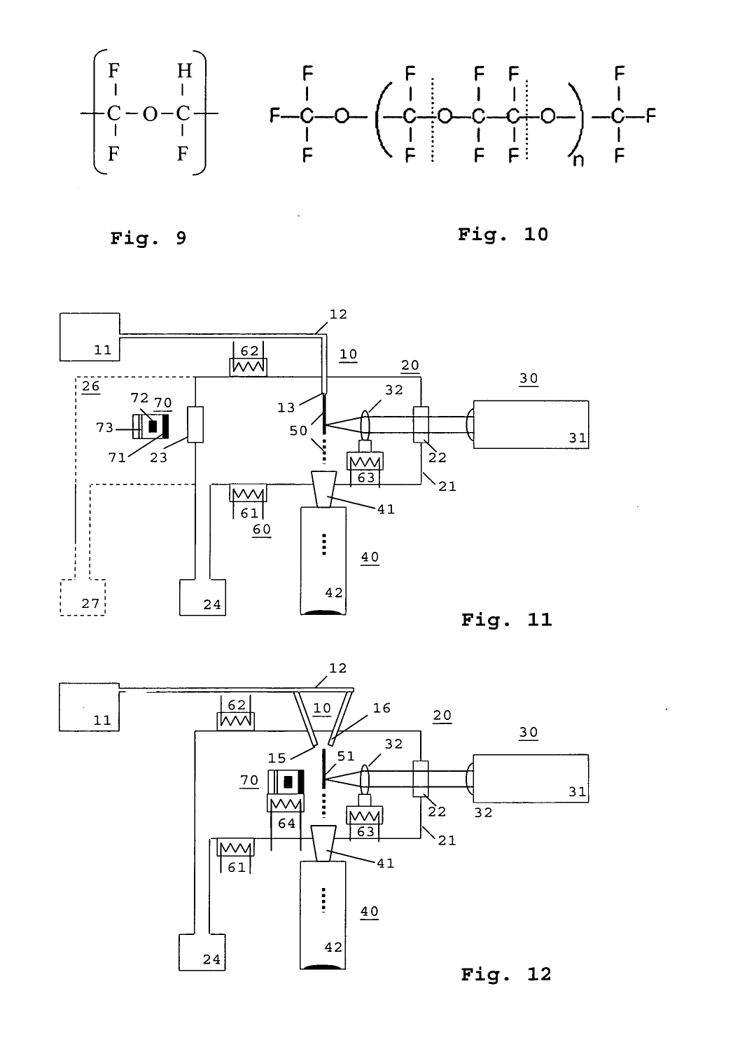

FIGS. 7 and 8: illustrations of the generation of a surface target from two primary jets,

FIGS. 9/10: structure formulae for the characterization of the target material used according to the invention, and

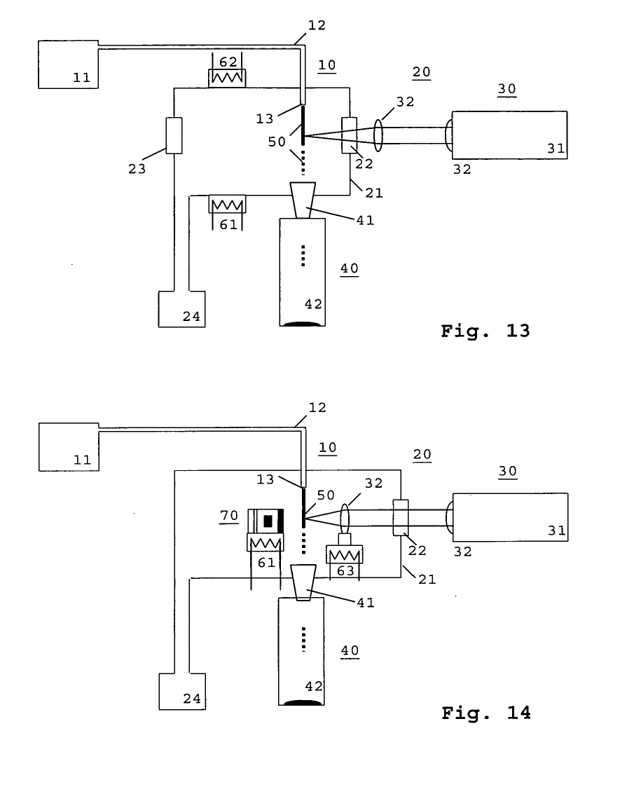

FIGS. 11 to 14: schematic illustrations of embodiments of an X-ray source according to the invention.

FIG. 1 illustrates the generation and irradiation, according to the invention, of a liquid target material 50 located self-supportingly in a space under vacuum conditions with a weakly curved surface at least on one side. The target material 50 is formed as a flow structural formation whose cross-sectional surface vertical to the direction of flow is illustrated in an exemplary manner. The target material 50 is irradiated with an irradiation device 30 (see below). The irradiation is directed to the surface 52 of the flow structural formation 51, at which locally the curvature radius is at its maximum and the curve is at its minimum. In this way, the external irradiation with the entire focusing cross-section can be essentially effected vertically on the surface 52.

In the illustrated example, the flow structural formation 51 has a long-stretched and particularly elliptical cross-section. The y-direction forms a main axis direction in which the flow structural formation has the longitudinal expansion Δy. The x-direction with the smaller transverse expansion Δx forms the auxiliary axis direction in which also the irradiation takes place. The target material 50 has, for example, the following geometrical parameters: longitudinal expansion Δy: 100 μm to 20 mm, transverse expansion at the location of the irradiation Δx: 2 μm to 2 mm, vertical clearance of the illustrated cross-sectional surface of the nozzle of a target source: 0.1 mm to 10 cm.

FIGS. 2 and 3 show the generation of non-cylindrical liquid forms with the use of a nozzle having a slot-shaped outlet opening. FIG. 2 shows the end of the nozzle 13, protruding into the vacuum chamber (see below) with the slot-shaped outlet opening 14. The geometrical structural configuration of the nozzle as a slot-type nozzle is selected according to the desired form of the flow structural formation 51 (see also FIGS. 5, 6). However, the outlet opening 14 for producing the microjets according to the invention is formed with correspondingly smaller dimensions. The slot has, for example, a width of 0.1 mm and a length of 3 mm.

From the nozzle 13, target material goes through the slot-shaped outlet opening 14 into the vacuum chamber of the X-ray source. The outlet speed is selected in such a way that the target material does not freeze in the vacuum chamber and is, for example, about 20 to 100 m/s.

Non-cylindrical jets can have a changed jet form with increasing distance from the nozzle 13 that depends on the viscosity, surface tension and the speed of the emitting liquid. The non-cylindrical form of the flow remains upheld at first only over a finite range of a few millimeters. With the objective of minimizing the surface, an area reduction 53 (FIG. 2) forms at first with an essentially circular cross-section of the liquid target material. As a result of the inertia of the liquid moved in the jet, there is then a renewed widening 54 of the liquid target material 50.

The alternating cycle of area reductions and area widenings forms an oscillating structure, which has already been theoretically described mathematically by Rayleigh in “Proceedings of the Royal Society”, Volume 29, 1879, pages 71 to 97, and is illustrated in FIG. 3. Area reductions 53 and widenings 54 are formed alternatingly, the orientation of the widenings 54 being alternatingly vertical and parallel to the drawing plane. Advantageously, the irradiation of the target material can take place at the location of a widening 54 after several periods of the oscillating structure where there is a relatively large distance from the nozzle 13. The setting of a possibly large distance of the plasma produced in the target material from the nozzle has the particular advantage that the outlet opening of the nozzle is protected against an erosion by the released radiation or by charged particles coming from the plasma or by plasma-induced radiation.

The form of the oscillating structure, particularly the number of the realized widenings 54 and their distance from the nozzle, can be set particularly by means of a suitable selection of the viscosity of the liquid target material. Thus, the target material can be advantageously selected for an optimal focusing of the external irradiation. If the target material is a high-viscous liquid, then the shown oscillations do not form themselves. In this case, the flow structural formation with elliptical cross-section remains relatively wide after the outlet opening 14 and goes over into the cylindrical form without any re-oscillation. In this case, the irradiation takes place in the zone of the primary widening in accordance with the slot-shaped character of the flow structural formation.

In a schematic and enlarged view, FIG. 4 illustrates the cross-sectional surface of a concave flow structural formation 51 with both sides arched to the inside. The surface 52 has, relative to the middle of the flow structural formation 51, a negative curvature radius or curvature radius pattern so that the thickness Δx in towards the center is diminished. The thickness can be diminished from the periphery to the middle, for example, by up to 99% and can be selected in the range of 500 nm to 500 μm. Deviating from the illustration in FIG. 4, a merely one-sided concave dome-shaped form can be provided.

The irradiation of the flow structural formation 51 is performed preferably perpendicular onto the surface 52 at the location of the minimal transverse expansion Δx. Depending on the material or the geometry of the irradiation, it can be advantageous as an alternative to irradiate the surface 52 outside of the location of the smallest transverse expansion.

The cross-sectional form of the flow structural formation is particularly determined by the design of the nozzle of the target source. It was surprisingly found that, in particular, the concave or dumb-bell shaped flow form according to FIG. 4 can be characteristically applied to the flow structural formation by means of a suitable nozzle form, and remains stable upon exit into an area with sub-atmospheric pressure (particularly vacuum) over a sufficiently large distance.

In principle, the nozzle 13 can be formed by means of a slot-shaped opening 14 at the end of a line for the target material (FIG. 2). Particular advantages for a stable non-cylindrical jet result from the use of a nozzle configuration structure, which is illustrated in FIGS. 5 and 6. FIG. 5 shows the port or outlet opening of a nozzle 13 in the direction of flow (from the inside, left partial image) and against the direction of flow (from the outside, right partial image). On the inside, a nozzle slot 14a is provided that stretches out over the entire width of the outlet opening 14 and whose slot width diminishes in the direction of flow (see right partial image in FIG. 6). In the direction of flow and adjoining the nozzle slot 14a, a cone-shaped port 14b is provided through which the target material 50 exits into the vacuum chamber (see FIG. 6). The flowing target material is first pressed through the nozzle slot 14a, the target material running together. Then, the target material runs apart at the rims of the conical opening 14b so that the desired lamella form of the flow structural formation results. The first oscillation of the flow structural formation (see FIG. 3) is influenced by the conical opening 14b.

A particular advantage of the nozzle 13 according to FIG. 5 lies in the fact that the concave form of the flow structural formation according to FIG. 4 is formed by the interaction of the nozzle slot 14a and the conical opening 14b. The thickness of the flow structural formation 51 increases in the direction of the rims (see dashed line in FIG. 6).

According to a preferred embodiment of the invention, the nozzle for producing the flattened-off flow structural formation is arranged in a rotatable manner. The rotatability refers to the axis of the outlet direction or injection direction or flow direction of the target material through the nozzle. The rotating capability can, for example, be realized by the use of a rotary holder of the nozzle and a flexible liquid line of the target source. As an alternative, a rigid liquid line can be joined with the nozzle by way of a rotary coupling. For setting a certain alignment of the nozzle, particularly relative to the irradiation device, the nozzle is provided with an actuator which, for example, comprises a stepper motor or a piezoelectric drive.

The FIGS. 7 and 8 illustrate the forming of the flow structural formation 51 at the impact surface between two primary jets 55, 56 of the target material, which are directed onto each other in the vacuum chamber with two separate nozzles 15, 16. The FIGS. 7A to 7C are based, with regard to drawing, on illustrations from the known publications of G. Taylor. According to the invention and according to the FIGS. 7A and 8A, two primary jets with a diameter of e.g., 30 μm at an angle of e.g., 60° are led together so that the flow structural formation 51 forms itself with a thickness of less than 30 μm (e.g. 3 μm) and an expansion of e.g., 1 to 2 mm. If, according to FIG. 7B, the meeting of the primary jets 55, 56 takes place at an increased angle of intersection of e.g., 90°, the flow structural formation 51 is also formed above the impact surface, there results a larger expansion of the sheet of the flow structural formation 51. If the nozzles 15, 16 according to FIG. 8B or 8C are aligned in opposing directions at 180°, there results a flow structural formation 51 according to FIG. 7C, which can be irradiated horizontally on the side (FIG. 8B) or vertically by way of a deflection mirror (FIG. 8C).

Generally, the location of the meeting of the primary jets is selected in such a way that the primary jets are not yet decomposed into drops (distance from the nozzles less than the drop decomposition distance). The nozzles 15, 16 can have circular or slot-shaped cross-sectional surfaces, particularly elliptical or rectangular cross-sectional surfaces.

The uniting of two jets (primary jets) has the advantage that the forming of the flat flow structural formation is variable in the space. In this case also, the flow structural formation can be provided with an increased distance from the nozzle 13.

The target material preferably used according to the invention in a plasma X-ray source is based on a polymer hydrocarbon compound, which is liquid at ambient temperature, particularly with at least an ether binding. One component of such a hydrocarbon compound is illustrated in an exemplary manner in FIG. 9. It is emphasized here that the implementation of the invention is not limited to the illustrated examples. As alternatives to the fluorinated polyethers, non-fluorinated polymers, mixtures from fluorinated and non-fluorinated polymers or polymers with a minor solvent portion (smaller than 20 vol.-%) generally can also be according to the invention. Furthermore, the fluorination can be substituted at least partially by an other halogenation, particularly a chlorination.

The target material shown in an exemplary manner in FIG. 9 consists of a multiplicity of such components or components constructed correspondingly from C, F, O and, if necessary, H, so that a non-easily volatile polymer is formed. The use of the non-easily volatile polymer advantageously diminishes the requirements on the vacuum system of an X-ray source.

The target material forms in particular a partially or perfluorinated polyether (PFPE) or a mixture of several partially fluorinated or perfluorinated polyethers. A perfluoropolyether is shown in exemplary manner in FIG. 10. This substance class also includes the PFPE compounds FOMBLIN (registered trademark) and GALDEN (registered trademark).

FIG. 11 shows schematically an example of an X-ray source according to the invention. The X-ray source comprises a target source 10, which is connected to a tempered vacuum chamber 20, an irradiation device 30 and a collection device 40.

The target source 10 comprises a reservoir 11 for the target material, a supply line 12 and a nozzle 13. With an actuating device (not shown), comprising for example a pump or a piezoelectric conveying device, the target material is led to the nozzle 13 and is discharged from this in the form of a liquid jet 50 and injected into the vacuum chamber 20.

The liquid jet 50 is injected, for example as shown, vertically into the vacuum chamber 20. As an alternative and for the implementation of the invention, another jet stream direction can be provided such as a horizontal injection or an injection at another angle relative to the horizontal.

The irradiation device 30 comprises a radiation source 31 and a radiation optical system 32, with which the radiation from the radiation source 31 can be focused onto the target material 50. The radiation source 31 is for example a laser whose light, as necessary, is directed with the help of deflection mirrors (not shown) towards the target material. As an alternative an ion-source or an electron-source, which is co-arranged in the chamber 20, can be provided as an irradiation device.

The collection device 40 comprises a cavity 41 e.g., in the form of a funnel or a capillary, which removes target material not evaporated under the effects of the irradiation from the vacuum chamber and leads it into a collecting vessel 42. Due to the use of the liquid polymer as a target material, the collected liquid can be collected advantageously in the collecting vessel 42 without any further measures. If the case arises and in order to avoid a return flow of collected target material into the vacuum chamber 20, a cooling of the collecting vessel 42 with a cooling device (not shown) and/or a vacuum pump (not shown) can be provided.

The vacuum chamber 20 comprises a housing 21 with at least one first window 22, through which the target material can be irradiated, and at least one second window 23, through which the generated X-radiation exits. The second window 23 is optionally provided in order to output the generated X-radiation from the vacuum chamber 20 for a certain application. If this is not required, the second window 23 can be dispensed with (see below). The vacuum chamber 20 is furthermore connected to a vacuum device 24 with which a sub-atmospheric pressure is produced. This sub-atmospheric pressure lies preferably below 10⁻⁴ mbar. The irradiation optical system 32 is also arranged in the vacuum chamber 20.

The vacuum chamber 20 is equipped with a heating device 60, which comprises one or more thermostats 61 to 63. The housing 21, the cavity 41 and/or the irradiation optical system 32 can be tempered with the thermostats. If required, the target source 10 can also be tempered. A thermostat comprises for example a resistor heating unit, known as such.

The temperature set with the heating device 60 is selected in such a way that the vapor pressure of particularly the polymer target material exceeds the gas pressure that is formed by the irradiation of the target material 50 with the irradiation device 30. In this way, and according to the invention, an oversaturation of the gas phase in the vacuum chamber is avoided. The released polymer remains gaseous and can be pumped off almost quantitatively with the vacuum device 24.

The second window 23 consists of transparent window material for soft X-radiation, e.g., of beryllium. If the second window 23 is provided, an evacuation-capable processing chamber 26 can follow up, which is connected with a further vacuum device 27. In the processing chamber 26, the X-radiation can be imaged to an object for material processing. For example, an X-ray lithography device 70 is provided with which the surface of a semiconductor substrate is irradiated. The spatial separation of the X-ray source in the vacuum chamber 20 and the X-ray lithography device 70 in the processing chamber has the advantage that the material to be processed is notsubjected to the deposits of evaporated target material.

The X-ray lithography device 70 comprises, for example, a filter 71 for the selection of the desired X-ray wave length, a mask 72 and the substrate 73 to be irradiated. In addition, imaging optics (e.g., a mirror) can be provided in order to guide the X-radiation onto the device 70.

With the modified embodiment of the invention according to FIG. 12, the X-ray lithography device 70 is arranged in the vacuum chamber 20. The device 70 is also connected to a thermostat 64 in order to avoid precipitations. Furthermore, FIG. 12 illustrates the use of a double nozzle 15, 16 (see FIG. 8) for the generation of flow structural formations according to FIG. 7.

If the irradiation optical system 32 according to FIG. 13 is arranged outside of the vacuum chamber, a separate tempering can be advantageously omitted. In this case, however, the window 22 must be sufficiently stable with regard to the at least partially focused and, if the case arises, the high-repetitive radiation of the radiation source 31. Furthermore, the target material 50 is conducted relatively close (e.g. at a distance of a few cm) past the window 22 with this embodiment. A double nozzle can be used for this embodiment also instead of the illustrated nozzle 13.

If liquid polymers are used as target material whose vapor pressure is so high that a tempering of the housing 21 is not required, sensitive components of the vacuum chamber 20, e.g., the imaging optical system 32 or the device 70 should nevertheless be heated. This embodiment of the invention is illustrated in FIG. 14. With the local heating, it is advantageously achieved that the target material released during irradiation is preferably deposited on the colder walls of the housing 21. The sensitive components, which are important for the individual application, are protected in the process.

For the generation of X-radiation according to the invention, a jet or drops of the target material 50 is produced with the target source 10 in the form of the flow structural formation according to the invention. The flow structural formation 50 is irradiated with the irradiation device 30 in the way that is known as such. The irradiation is performed in a focused manner with such an intensity that the target material is transformed into a plasma condition. For example, an energy input of 100 mJ per radiation pulse (e.g., per laser shot) is provided. With a pulse rate of 10 kHz, an output power of up to 50 W is achieved in this case. In the plasma condition, soft X-radiation is emitted and, as required, tapped for the individual application through the second window 23.

The X-radiation comprises a wavelength range of up to approximately 15 nm. Advantageously, particularly the Kα-line is emitted with λ=3.37 nm, F-lines with λ=0.7 nm up to 1.7 nm and 12.6 nm and the O-line with λ=13 nm. It is particularly advantageous that, with the use of perfluoropolyether, the carbon-Kα-line can be generated with the avoidance of disturbing graphite deposits. In the X-ray microscopy, the Kα-line is of major interest because this falls into the so-called “water window”, in which no X-ray absorption occurs as a result of water. With the permanent avoidance of erosion and deposits, the X-ray source according to the invention is suitable to an excellent degree for X-ray microscopic and lithographic applications. A further advantage results from the miniaturization of the structural configuration. The device 70 (see FIG. 12) can be arranged in the immediate vicinity of the focus of the irradiation device 30.

Because of the low volatility of the material used according to the invention, the collection device 40 can be advantageously operated without a coolant and without a cooling device. In particular, it is not necessary to provide a so-called cryotrap or a separator for the condensation of residual materials. The pickup 41 and the collecting vessel 42 are directly connected with one another.

The residual materials not collected by the collection device 40 are, advantageously, easily volatile components, which can be removed from the chamber 20 with the vacuum device 24. The vacuum devices 24, 27 comprise, for example, rotary vane type oil pumps.

Preferred applications of the X-ray source according to the invention are in the analytical chemistry, in the X-ray microscopy, in the X-ray lithography and in the combination with further spectroscopic measuring methods, such as the fs spectroscopy.

Further applications of the invention are everywhere where there is an interest in the examination or in the use of free liquids under vacuum conditions. For example, liquid samples for photoelectron or photo absorption spectroscopic examinations or corresponding scatter experiments corresponding to the technique according to the invention can be introduced into the respective examination chamber. A high-energetic irradiation or a particle shot can be provided.

An alternative application of sheet-type target materials according to the invention exists with, as required, time-resolved X-ray absorption experiments with synchrotron radiation (refer to K. R. Wilson et al. in “J. Phys. Chem. B”, Vol. 105, 2001, pages 3346-3349). Even with these applications, the enlarged longitudinal expansion of the sheet flow is advantageous because the focusing of the radiation onto the target facilitates.

Finally, the liquid sheet formed according to the invention can be used as a source for drops or macrocluster (spray). After a finite distance from the nozzle, the flow structural formation decomposes into single drops, which are irradiated for the generation of X-radiation.

The features of the invention disclosed in the above description, the drawings and the Claims can be of significance both individually as well as in combination for the realization of the invention it its various embodiments and variants.

1. A method for the plasma-based generation of X-radiation, with the steps:
providing a target material in the form of a free flow structural formation in a vacuum chamber,
wherein the flow structural formation is formed in such a way that the target material, at least at a location of irradiation, has a surface with a local curvature minimum, and
irradiating the target material in order to produce a plasma condition in which the X-radiation is radiated therefrom.

2. The method according to claim 1 in which the flow structural formation has, at least at the location of the irradiation, a cross-sectional surface having in a main axis direction (y) a longitudinal expansion Δy that is larger than a transverse expansion Δx in an auxiliary axis direction (x) deviating from the main axis direction (y).

3. The method according to claim 2 in which the flow structural formation has, at least at the location of the irradiation, an oval cross-sectional surface or a rounded-off, rectangular cross-sectional surface.

4. The method according to claim 2 in which the flow structural formation forms, at least at the location of the irradiation, a free lamella-type sheet.

5. The method according to claim 2 in which the flow structural formation has, at least at the location of the irradiation, a concave surface at least on one side.

6. The method according to claim 1 where the flow structural formation of the target material is produced with a target source which has a nozzle with a non-circular outlet opening.

7. The method according to claim 6 where the flow structural formation of the target material is produced with a dispenser which has a nozzle with a slot-shaped outlet opening.

8. The method according to claim 6 where the nozzle for setting a predetermined alignment relative to the direction of the irradiation of the target material is rotated.

9. The method according to claim 1 in which the flow structural formation of the target material is produced with two primary jets which are led together for the formation of a free self-supporting liquid sheet at a predetermined angle.

10. The method according to claim 9 in which the primary jets are led together at an angle that is smaller than or equal to 180°.

11. The method according to claim 9 in which the primary jets are led together at an angle that is smaller than or equal to 90°.

12. The method according to claim 1 in which the flow structural formation of the target material is irradiated essentially perpendicular onto the surface with the local curvature minimum.

13. The method according to claim 1 in which the target material is selected from the group consisting of: at least one hydrocarbon compound comprising at least one polymer, which is liquid at ambient temperature, water, glycerine, alcohol, liquefied gas and liquid metal.

14. The method according to claim 13 in which the hydrocarbon compound used as target material has at least one ether binding between carbon atoms.

15. The method according to claim 14 in which the hydrocarbon compound used as target material has at least one partially fluorinated or perfluorinated polymer hydrocarbon ether.

16. The method according to claim 15 in which the hydrocarbon compound used as a target material has a perfluoropolyether or a mixture of perfluoropolyethers.

17. The method according to claim 13 in which the hydrocarbon compound used as target material has a vapor pressure at ambient temperature less than 10 mbar, a molecular weight larger than 100 g/mol and/or a viscosity in the range of 1 cS to 1800 cS.

18. The method according to claim 13, in which the irradiation of the target material takes place in a vacuum chamber which is at least locally heated in such a way that the vapor pressure of the target material is higher than the pressure of the gas, which is released by the irradiation of the target material.

19. The method according to claim 13 in which target material, after irradiation, is collected in a collection equipment at ambient temperature.

20. A method of using polymer hydrocarbon compounds, which are liquid at ambient pressure, for the provision of target material in the form of a flow structural formation, the target material having, at least at the location of a irradiation for the generation of soft X-radiation, a surface with a local curvature minimum.

21. A method of using partially fluorinated or perfluorinated polymer hydrocarbon ethers for the provision of target material in the form of a flow structural formation, the target material having, at least at the location of a irradiation for the generation of soft X-radiation, a surface with a local curvature minimum.

22. An X-ray source for plasma-based generation of X-radiation by means of high-energetic irradiation of a target material in the form of a free flow structural formation, comprising:
a target source that provides the target material in a vacuum chamber, and
wherein the target source is adapted for forming the target material in such a way that the target material in the flow structural formation has, at least at the location of the irradiation, a surface with a local curvature minimum, and
an irradiation equipment for irradiation the target material in the vacuum chamber.

23. The X-ray source according to claim 22 in which the target source has a nozzle with a non-circular outlet opening.

24. The X-ray source according to claim 23 in which the target source has a nozzle with a slot-shaped outlet opening.

25. The X-ray source according to claim 24 in which the target source has a nozzle with an outlet opening which is elliptic, rectangular, or convex and tapered towards the inside.

26. The X-ray source according to claim 24 in which the nozzle has an outlet opening with a nozzle slot and a conical opening.

27. The X-ray source according to claim 23 in which the nozzle in the vacuum chamber is arranged in a rotary manner.

28. The X-ray source according to claim 22 in which the target source has two nozzles for the production of primary jets, which are led together for the formation of a free self-supporting liquid sheet at a predetermined angle.

29. The X-ray source according to claim 28 in which the nozzles are aligned in such a way that the primary jets are led together at an angle of 180°.

30. The X-ray source according to claim 28 in which the nozzles are aligned in such a way that the primary jets are led together at an angle that is smaller than or equal to 90°.

31. The X-ray source according to claim 22 in which at least one heating dcvicc equipment is envisaged with which at least parts of the vacuum chamber can be tempered.

32. The X-ray source according to claim 31 in which the heating equipment comprises several thermostats, which are connected with components at and in the vacuum chamber.

33. The X-ray source according to claim 32 in which the irradiation equipment has an irradiation optical system, which is arranged in the vacuum chamber and is connected to a thermostat.

34. The X-ray source according to claim 22 in which the irradiation equipment has an irradiation optical system which is arranged outside of the vacuum chamber.

35. The X-ray source according to claim 22 in which a collection equipment is envisaged for collecting the target material after irradiation and is set up for the coolant-free operation.

36. The X-ray source according to claim 22 in which an X-ray lithography device is arranged in the vacuum chamber.

37. The X-ray source according to claim 36, in which the X-ray lithography device is connected with a thermostat.

38. The X-ray source according to claim 22, in which the vacuum chamber is joined to a processing chamber in which an X-ray lithography device is arranged.

39. A vacuum chamber with a nozzle with a slot-shaped outlet opening for injecting liquid target material into the vacuum chamber.

40. The vacuum chamber according to claim 39 in which the nozzle is arranged in a rotating manner around an axis that runs parallel to the direction of the injection of the liquid target material.

41. A method for the injection of a liquid target material in the form of a free flow structural formation into a vacuum chamber, comprising the step of:
forming the flow structural formation such that the target material has a surface with a local curvature minimum.

42. The method according to claim 41 in which the flow structural formation forms a free, lamella-shaped sheet.

43. The method according to cclaim 41 in which the flow structural formation has a concave surface at least on one side.
